(19) United States
(12) Patent Application Publication
(10) Pub. No.: US 2024/0296852 A1
(43) Pub. Date: Sep. 5, 2024

(54) Method and associated system for information and generic data transmission

(71) Applicant: OGENUS SRL, Padova (IT)

(72) Inventor: Luciano Murrone, Padova (IT)

(21) Appl. No.: 18/268,226

(22) PCT Filed: Feb. 15, 2021
(86) PCT No.: PCT/IB2021/051244

§ 371 Date: Jun. 17, 2023

(30) Foreign Application Priority Data
Dec. 23, 2020 (IT) 102020000032312

(51) Int. Cl. G10L 19/018; H04B 11/00

(52) U.S. Cl. CPC G10L 19/018; H04B 11/00

(57) ABSTRACT

A method for transmission of information or data in general, hereinafter referred to as information references, wherein the information references contain data/information to initiate procedures aimed at sending additional information/interactions/data to one or more Destinations, includes defining regulatory references to be transmitted by a Sender to one or more destinations; generating a coded sound signal which contains the information references; transmitting and emitting the coded sound signal with a first transducer or loudspeaker; receiving with a second transducer or microphone the coded sound signal emitted by the first transducer or loudspeaker; decoding the coded sound signal to start the procedures that lead to the delivery of additional information/interactions/data that the Sender wants to deliver to the Destination.

The present patent relates to communication and data transmission systems; in particular, it concerns a new information transmission system and method. The purpose of the system is to transmit information, such as the communication of data, strings of bits, signaling and, more in general, information references. The information is meant to be received mainly from mobile electronic devices such as smartphones, tablets and others, and processed by specific software applications installed on such devices.

Information transmission systems are known which make use of visual signals, such as the well-known QR code. The QR code is a technology, now widespread and frequently used, developed and patented in 1994 by Denso Wave (a company of the Toyota Group). In the QR code, the information is entrusted to a visual image, a two-dimensional bar matrix (or 2D code), consisting of black modules arranged within a white square pattern; the visual image is acquired by optical detection devices (led, webcam, . . . ) stored and intended to be interpreted and processed by software programs (or applications), generally activated on mobile devices.

The message associated with the QR Code often consists of an information reference, such as a URL, an implementation command, a limited binary string, which, appropriately interpreted by the software application for which it is intended, initiates an interaction or directs to a procedure that leads to the information that is meant to be sent to the end user.

### Synopsis

In the present patent, the information transmission system makes use of a sound transmission channel, that as of now has not been considered nor used for communication purposes of synthesized and concise codes, intended to simplify access to information or to initiate interaction procedures for end users of modern technologies.

In the present system, the information reference, that is the data/information to be transmitted, is contained in a sound signal, generally of short duration, composed of one or preferably more frequencies, for example between 20 Hz and 20 kHz, which can be also extended in the infrasound and/or ultrasound. The sound signal is generated in an electronic device through software and is ultimately emitted as a sound signal through a loudspeaker.

Said sound signal is then acquired by acoustic detection terminals, such as microphones and receivers of a generic electronic device and more generally by electro-acoustic transducers, stored and intended to be processed and interpreted by software programs or applications implemented in said or other electronic devices.

Some concepts that will be used in this description and which pertain to the multidisciplinary technological field globally recognized as ICT (Information and Communication Technology) are defined below.

### Information

The concept of “information” is closely related to the term “meaning,” which in turn connects to the idea of “purpose”.

In its broadest expression, information could be defined as the (connected) meaning that emerges and manifests itself, on the basis of assumed conventions (codes, alphabets, languages, . . . ) between sentient beings or cognitive apparatuses, in all things or concepts (abstract or concrete, single or structured) which, in the shared objective reality, are recognized as having an end. Information can have one or more expressive and interpretative forms and is conveyed and differs from a qualitative and a quantitative standpoint. The quality is connected to the expressive modality, the intrinsic meaning, and the associated purpose, while the quantity is attributed to the measurement and to the dimensional aspects related to the adopted conventions.

In the field of ICT this results in:
a property of quality in the general conception of the systems that must finalize the information transfer
a quantitative domain for the precise definition of the devices that must manage the information

### Code

The notion of “code” associated with information content connects to the definition of a “convention”.

A code (or alternatively language, alphabet, lexicon, . . . ) is a tool that allows to associate, store, manage information, according to standardized practices, recognized, shared, and related to human senses and detection systems. The code is essential for the building a message, that is the most common means of expressing and transmitting information. The code is the conventional basis used in systems, articulated and structured even in multiple hierarchical levels, identified as fundamental tools that contain information.

For instance, a code can be:
the range of colors in a “visual” environment
the definition of “musical notes” conventionally used to compose, interpret and reproduce musical harmonies
the specification of sign elements which, possibly associated, lead to the formal definition of a conventional language (alphabet)
the set of phonemes that express the sounds of common speech (lexicon)

The nature of coding must imply uniqueness, through procedures defined in advance, so that it is possible to translate the information, according to a specific code, without ambiguity.

In the context of ICT, a typical digital code is the binary representation, the simplest conventional formal system that uses only two symbols (zero and one), to which any numeric representation can be traced back with a suitable binary map.

### Communication

The definition of “communication” is directly linked to the concept of “information.”

A shared objective reality presupposes the sharing of common information between sentient beings or cognitive apparatuses; this can happen only if the latter can be transferred between individuals or from one place to another: this peculiarity (the transfer of information) is recognized as communication (mainly entrusted to messages).

In modern society and in universal conventions, there is a tendency to make the concepts of “communication” and “information” coincide, but in the engineering field, communication must only mean “transmitting information”. Therefore, on the basis of a common conventional code, a source and issuer of the information, a means (or channel) of transmission, a subject receiving and interpreting the information must be presumed.

Similarly, the communication concept is also expressed through quantitative and qualitative characters.

From an engineering point of view, the quantitative concept of communication expresses, in logarithmic terms, the uncertainty of a message among those conventionally considered possible. In practice, it refers to the same interpretation notion as related to the information (ultimately, it similarly involves the measurement and the dimensional aspects related to the adopted conventions), whereas the quality is specifically defined as the capability to reconstitute the message arrived at the destination's side with the same information amount as originated at the sender's side.

The context of ICT implies to consider
a quantitative domain for the precise definition of the devices handling the communication
a qualitative property for the actual conception of the systems transferring the communication

### Communication Scheme

In the communication scheme, the sender and destination are the source of the information and the entity designated to receive and interpret it, respectively.

The mathematical model of communication provides, as a Communication Process, an exchange of information between subjects who assume (and possibly switch) the roles of sender and destination, and this every time the transmission of information (mutual communication) takes place.

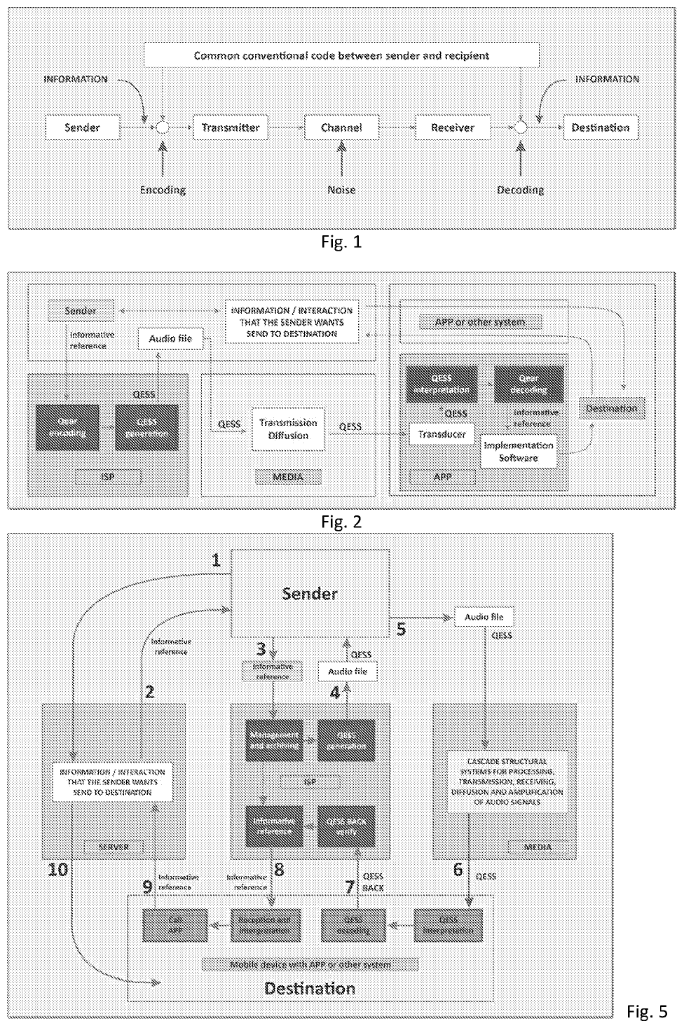

For the sake of this discussion, it is assumed that the Communication Process is unilateral (or unidirectional from a sender to a destination), implying that similar and more complex interactions could occur considering also changing roles, the presence of a feedback and the multiplication of the functionalities analyzed in the fundamental scheme (see FIG. 1).

This interpretation of the Communication Process is suitable for most of the applications envisaged for the information transmission system described and claimed in the present patent application.

As shown in FIG. 1, the exchange of information between the Sender and the Destination is carried out at the physical level by implementing a transduction towards the signal domain through the Coding operation (or also: modulation, synthesis) and, by inverting it, through the operation of Decoding (or also: demodulation, analysis). The Transmitter is therefore the physical element that carries out communication in practice, interacting with the Receiver, via a noisy Channel.

These elements will be specified below, with particular reference to new information transmission system.

### Sound Communication

Sound communication can be classified into various forms. It corresponds to the association and transmission of information through a sound effect, perceptible by the human hearing system or by an acoustic detection device.

Possible kinds of sound communication include:
a voice message, that is, expressed in words and phrases pronounced by a sentient being (or by a device that provides verbal meaning to the sounds emitted) and intended to be listened to and interpreted according to conventionally shared phonetic canons
a musical harmony, more or less structured, coordinated, and rhythmic (possibly combined or integrated with appropriately modulated phonemes and words) with the aim of being interpreted as a melodious motif and composition, destined to be perceived to ingenerate pleasant sensations, instinctive emotions, and/or intellectual satisfactions
a signaling (sound) message, with more or less continuous character, consisting of variously combined audio frequencies (but which could also belong to the domain of infrasound and/or ultrasound) of limited duration in time and intended to be decoded according to pre-set interpretative rules

### Information Reference

The innovation introduced by the proposed information transmission system involves the generation of a sound signal that contains information. This content is usually not exhaustive and can be identified as a reference (or link) that returns or initiates procedures leading to predetermined actions or information contents. In this system, the sender produces an information reference (a series of numbers and/or digits of an alphabet, a string of alphanumeric characters, a URL address, a series of data or conventional parameters associated with an APP . . . ), which constitutes the core of the new information transmission system intended for the software application (APP).

Within the proposed information transmission system, an “Information Reference” is defined as that part of the associated information that the sender wishes to submit to a potential destination.

In practice, the sender entrusts to a sound signal, coded, modulated, and produced according to the protocol of this system, the Information Reference, which is the one to be interpreted by specific APPs.

If the Information Reference is a URL, the new system is even more advantageous since it allows to send the encoding of this URL address, while the contents of the information can be entered and modified by the sender directly on the referred page.

Alternatively, the Information Reference can be instead a message sent to the ISP to request authorization in order to access the information content. In this way, the ISP will control the destination's access to the information that the sender wants to transmit. A diagram with the relative explanation of the latter solution is shown in a subsequent chapter called “ISP-BACK”.

### The Sound Signal

The sound signal produced, or the signal encoded according to the coding protocol of the proposed information transmission system, is an audio file that will be stored, managed, processed and transmitted through ICT channels and devices, such as in broadcasting systems.

The sound signal that a Sender submits is obtained with a specific procedure; for example, the Sender can entrust an Internet Service Provider (ISP) to perform it. The ISP is in turn enabled to use the new information transmission system and equipped with a specific development program, to encode the Information Reference, i.e. the information to be transmitted, as provided by the Sender. The ISP then encodes this information and includes it in a digital audio file, whose format can be mp3, wav, midi, aac, and so on, and which will be transmitted to the client, i.e., the Sender.

The Sender, in turn, may use said audio file for its purposes of diffusion among, or interaction with, its end users.

The sound signal is also recognizable by a human user, however it can also be seamlessly integrated into multimedia transmissions, together with forms of vocal message or musical harmony.

The sound signal contains, appropriately coded and digitally modulated, information that can only be interpreted through software applications (programs).

Once it reaches a receiving subject, i.e. the Destination, said signal is managed by a program (APP), where it is interpreted and decoded; such operations return the Information Reference, intended to initiate procedures to access the information/interactions that the Sender wishes to be sent to the Destination.

### System Procedure

The use of the proposed system presupposes that some use criteria have been foreseen, that is, the procedures that are assumed for its advantageous exploitation. A possible operational structure for the new information transmission system is discussed below.

The generic transmission scheme, illustrated in FIG. 2, brings together the functionalities and operational purposes of the new information transmission system and briefly outlines its operation. The purpose of the system is, ultimately, to lead the user towards the information/interaction that the Sender wishes to send to the Destination.

The areas of innovation, subject to patent development, concern:
in the ISP management sector, the Coding and Generation of the sound signal in the context of software applications (APP), the interpretation and decoding of the sound signal

The preliminary activities carried out by the Sender, or by those who desire to send specific information to (or implement an interactive activity with) the Destination, enable the preparation of the information/interaction (generally published/activated on the web) and its identification (with data, parameters and URL address) in an Information Reference.

The Information Reference, which by its nature is generally complex, articulated, and difficult to be reproduced and/or memorized, can be sent to the Destination(s) as a sound signal. For this reason, it must be encoded (according to the encoding protocol, described below) and included in an audio file (sound signal), an operation that can for example be carried out by an authorized ISP. Once the audio file (QESS) containing the information to transmit, encoded, and generated by the ISP, has been obtained, the Sender may disclose/transmit it (on broadcasting channels, through multimedia devices, by means of loudspeakers in public environments, etc.), in such a way as to make it reach the potential Destination(s) concerned. The Destination(s) will be in turn equipped with electronic devices where an APP is installed that allows to interpret and decode the audio file; ths, they will be able to access, with the reconstituted Information Reference, the information/interaction prepared by the Sender.

### Boundary Conditions

In order to define the specifications of the new system in a coherent and exhaustive way, the main boundary condition is reported which is considered essential for the correct development of the theoretical scope of innovation subject of this study.

### Contrasting Noise Through Coding

It should be specified that, in practice, sound signals are affected by noise. This term means, in the engineering field, an unwanted signal that contrasts with the so-called useful signal, which is instead explicitly designed for the transport of information. In the case of sound communication, noise can be both an unwanted acoustic signal, as understood in common language, as well as a secondary effect due to the imperfections of electrical devices communicating the signal. In any case, the presence of noise in communications not only does not provide any contribution to the information exchange, but makes it more difficult to execute. The encoding of an information content into a message to be transmitted through an appropriate signal, which in this case is a sound signal, therefore has a dual function of conventional mapping that can be interpreted but also of contrasting noise.

Since the noise generally has random and poorly structured characteristics, in the presence of overlap between the useful signal and the noise, it is still possible to isolate the useful signal as it possesses characteristics of internal structure, as opposed to noise.

This property is generally present in any coding, however additional techniques are often identified theoretically to be particularly suitable for countering noise even when the corruption it brings to the useful signal is considerable. Beyond the specific detail of the particular encodings, the general principle is to introduce redundancy in the signal, or a greater degree of structuring, not to increase the information content but solely aimed at contrasting the noise. In light of this principle, the coded sound signal must have both aspects related to coding, that is, not only provide for a conventional mapping of the information, but do it so as to present robustness characteristics with respect to noise. In other words, the specifications of the coded sound signal guarantee that it is capable of transmitting the information content even in the presence of noise, within certain levels. The performance of the proposed system is actually related to the ability for this to happen.

### The Coding Protocol

The subject of innovation, relating to this patent proposal, consists of the coding system and the generation of the encoded sound signal, expressed in an audio file, as well as the interpretation and decoding of the latter for the restoration of the original Information Reference, i.e., the content of information to be transmitted. Both of these processes will be elaborated and derived below. The coded sound signal, produced in the form of an electrical signal, has in its envelope the information that the sender wants to be transmitted to the destination device. This can be done through acoustic synthesis programs that are able to generate, modulate and compose audio frequencies according to defined standards. The rules for coding the sound signal will not simply define the frequencies to be associated, but must also introduce redundancy in the data to be transmitted.

### Preliminary Technical Notations

Two-dimensional structures for information coding are already applied in the field of graphic signals. In this context, the reference one-dimensional structure is that used for bar codes, which provide a reliable graphic signal typically used for product tracking. Reading the code through an optical scanner allows it to be interpreted quickly and effectively.

Subsequent evolutions of this technology towards a two-dimensional structure involve graphic coding, such as the QR Codes but also the VeriCode and the Data Matrix, which increases the data content compared to the barcode with the same graphic area.

The present information coding system, on the other hand, involves a sound signal that presents a two-dimensional mapping along the directions of time and frequency.

This solution, suitable for still practically unexplored scenarios, offers the advantage of efficient data transport in a similar way to spatial two-dimensional code. In its elementary version, the coded sound signal of the present patent application has characteristics of content and robustness similar to those of a two-dimensional graphic code, since, even in the presence of a different physical signal format, it has similar structural properties.

### Message Structure-Coded Sound Signal

The coded sound signal, before being disseminated, can be processed, transformed, and adapted; however, the required preliminary step is its generation; in other words, after establishing the information content associated with the exchange, this must be coded.

Assuming an information of a digital type (bit strings), it is necessary to adapt it in a specific structure, so that it assumes a defined conformation, to guarantee the possibility of an adequate level of security, in terms of specific preliminary encryption, and reliability, in terms of redundancy and correction for the reconstruction of the original information. It is also possible to provide that, unless further verification and management procedures are carried out, the individual signals may vary according to pre-ordered ranges of frequencies and pre-determined time steps.

The information associated with the coded sound signal, or better its aggregation within the coded sound signal, is structured and made up of the following parts:
an Opening Marker, in the form of a jingle, recognizable by detection systems
the signal core, called “Info Core”, that is the inner part containing the coded Information Reference, i.e., the information content to transmit
a Closing Marker, once again a recognizable jingle detectable by proper systems

The coded sound signal is therefore temporally limited by two sequences, easily recognizable and identified as opening jingle (Opening Marker) and closing jingle (Closing Marker). These conventional sequences, in addition to the function of denoting the beginning and end of the coded sound signal, also provide a unique identifier of the version used for the two-dimensional coding of the information.

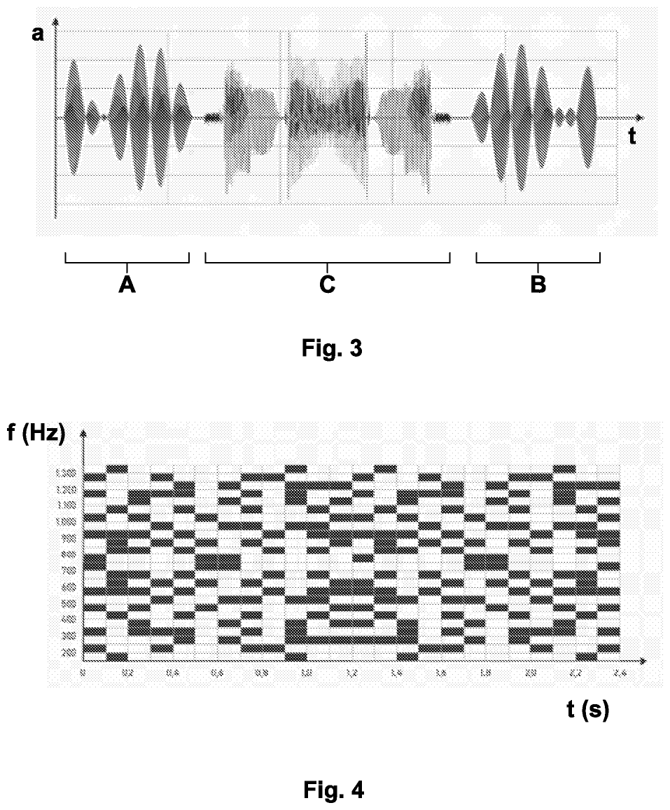

FIG. 3 shows a temporal representation of the coded sound signal structure, where the opening marker signal or “Opening Marker” is indicated with (A), the signal core, or “Info Core”, is indicated with (C) and the closing marker signal or “Closing Marker” is indicated with (B).

The structure of the transmitted message must exhibit characteristics of robustness with respect to noise, therefore the following measures will be adopted in the coded acoustic signal.
The Opening and Closing markers must be strongly structured; in fact, they constitute a control element of the communication that does not carry any information, except that of the beginning or end of the message. However, they will be of adequate length and composition to allow their recognition by both automatic devices and human users, even in the presence of noise
The Info Core shall be expanded following the introduction of redundancy in the signal, in order to provide adequate protection against noise. Managing redundancy is the goal of the coding operations, where it is introduced, and decoding, where it is exploited to counteract noise.

### The Configuration Model of the Info Core, the Payload of the Signal

The Information Reference, i.e., the information to be transmitted, according to the predefined methodology, is transformed into a succession of signals of predetermined duration with overlapping frequencies over time (the Info Core). The Info Core contains a layer of coding implemented in multiple directions. As a main example, consider a two-dimensional arrangement of the digital values of the signal along the directions of time and frequency. In the simplest possible version, the digital values are binary (0/1, i.e., absent/present). Expansions of the coding layer into several levels, using disjoint frequency ranges, may also be envisioned.

Within the coding layer, an appropriate subdivision of time and frequency step is identified, which provides the elementary resolution of the coding symbols. FIG. 4 shows a possible example of a time/frequency matrix usable for the “Info Core”.

### Two-Dimensional Coding

An example of a possible model could be the Two-dimensional Coding, which takes its cue from the information configuration of the QR Code, whose graphic reference model, i.e. a two-dimensional image used for the transport of coded information, generally adopts a matrix of monochromatic (with binary value 0/1) square pixels of standard size, variable according to the purposes and the information content to be disclosed.

To obtain the same performance in the encoded sound signal, the following choices can be made.
A value N is preliminarily set, depending on the characteristics of the coding format used, for example N=24.
A pre-set limited frequency range is used, including A values chosen as harmonics, i.e., fundamental frequencies that may or may not be present in the acoustic signal.
A total duration of the acoustic signal of a few seconds is set, further divided into T time intervals, generally of identical duration.

A formatting akin to a square spatial representation would correspond to imposing A=T=N. For practical reasons of implementation, it is however possible to choose a rectangular representation instead of a square, in which the number of harmonics A does not coincide with the number of time intervals T, but a similar value is retained for the product A×T.

### Format of the Coded Content

The overall content of the two-dimensional data structure is the result of an encoding operation carried out on an initial message (payload), whose maximum allowed size depends on the specific format used (which in turn determines the N value), as well as on the robustness settings for what concerns the code correction capability.

In fact, as justified by information theory, error control occurs by adding appropriate redundancy to the payload, which improves its recognition even in the presence of noise. It is also possible to provide for a dual way of formatting the encoded content, so that the generated two-dimensional structure is characterized by:
minimum possible frequency occupancy to contain the original message and the redundancy introduced, for example by limiting the number of harmonics used;
minimum possible duration to contain the original message and the redundancy introduced.

Another design choice concerns the specific coding technique used for the generation of redundancy. In this context, it is possible to use high-efficiency binary block codes such as Reed-Solomon codes, already used by graphic encoded representations for error protection. Analogous to similar systems in the field of graphic signals, these choices allow protection from error even in the case of loss of 30% of the coded sound signal.

### Acoustic Signal Generation

The “Info Core” part in the structure of the message corresponds to the sequencing of the time-frequency matrix structure according to the format specified in the sample model described above. A simplified acoustic generation, in a server accessible via the web, could provide that, upon receiving the sequence of characters to be encoded, it directly generates the sound signal according to the encoding and structure shown, and allows it to be saved in standard audio file format, such as mp3, wav, midi, aac, . . . .

### Processing and Decoding

Within this system, a Receiver of sound information comprises an electronic device with proper software installed to process and decode with certainty the encoded sound signal detected by a microphone connected to the Receiver's device. In practice, the electronic device of the Receiver coincides with the Receiver itself.

The coded sound signal, after being encoded and broadcast or transmitted, is perceived by electro-acoustic transducers, that demodulate it to isolate the transmitted content, and then decoded to obtain the original information. Through acoustic analysis programs, able to filter, select, and transpose the audio frequencies, the demodulation system, after the required error corrections, extracts and interprets the original information content, which will be used for further processing to implement the information purposes of the system.

In the example of model described, the analysis of the generated coded sound signal takes place through the following two phases.
1. Structural interpretation of the acoustic signal to identify the binary values in the time and frequency domains; this operation is performed by an electroacoustic apparatus connected to a suitable application that reads the frequency occupation values of the different harmonics and provides a coded binary output sequence.
2. Decoding of the binary sequence to obtain the original payload message, correcting the error, i.e., removing the redundancy and using it to verify the values received.

Depending on the implementation, the latter operation can be performed locally, i.e., on the receiver's mobile device, provided that the encoding format and specifications like the frequency values adopted are communicated, in the same signal or by other means.

Alternatively, an external architecture may be used through a reference server, which receives and interprets the binary sequence.

### Cryptography

To allow for a flexible and general implementation, the coding and decoding scheme operates without any structural encryption. However, since the content of the payload message is general, it is possible to introduce end-to-end encryption into the system to protect any sensitive information.

### Final Technical Considerations

The reception of data through the new information transmission system takes place automatically and, therefore, has a higher execution speed than any other form of data exchange that takes place internally on the acoustic channel. Although other forms of data diffusion (or exchange) are possible through sound communication channels, these are not so general, as they depend on the technology and equipment of the transmission and reception equipment.

The coded sound signal of this new system, on the other hand, is permanently inserted within the diffused acoustic content, for example, similarly to the insertion of QR codes in magazines, flyers, road signs, video screens, and so on. The possible configuration models, adaptable to the sound channel and associable with the system, such as the proposed two-dimensional coding example, have great data storage capacity, akin to what is found in graphic systems based on the visual channel. Additionally, interfacing with mobile devices or smart audio management systems allows rapid integration with text and video multimedia content, for example via hyperlinks.

The previously exemplified structure of two-dimensional time/frequency collocation of binary values is only one of the possible structures that can be adopted in the coding of the sound signal, it is also possible to realize sequentialization models, multi-level modulation, differential representation, and others.

Analogous to the QR Code, the present system for transmitting information by means of a coded sound signal could also provide for a multi-modal management for the types of use of the Information Reference: for example, the purposes of the coded sound signal could be associated with a code of static or dynamic type. The Information Reference that will be entrusted to the transmission system, as well as the results of the coding, generation, interpretation and decoding processing of the encoded sound signal, will be classified, registered and stored in a database archive, exclusively managed by the ISP authorized to use the system.

### Software

To preliminarily define the synthesis (coding and generation) and analysis (interpretation and decoding) systems that will operate on the coded sound code, the main functions of the software implemented in the process of the new information transmission system are outlined.

### Encoding and Generation Applications

The program to synthesize the coded sound signal, placed for example in a server managed by an ISP, can operate according to the following application procedure.

The program receives an input file containing the Information Reference, which can be a URL address, or any other information to be transmitted. The file is defined and specified according to conventions to be established in relation to the configuration models.

Based on pre-established parameters and/or included in the file itself, the Information Reference is encrypted to becomes an EIR (Encrypted Information Reference) file.

The program then modulates/synthesizes the EIR file in an enveloped sound signal, according to techniques that could provide for optimization (redundancy, error correction, noise reduction).

Finally, an audio file is generated which represents the encoded sound signal (in mp3, wav, midi, aac, . . . format).

### Acquisition and Decoding Applications

The analysis software, residing in a device accessible to the final receiver, can be implemented in specific applications (APP), created for certain purposes, or have standard interpretation/implementation characteristics, for example as an exclusive addressing service dedicated to the Information Reference.

The general execution procedure involves the following operations.
It is activated and terminated by means of a specific sound signal which conveniently consists of said “Opening Marker” and/or said “Closing Marker”-generically associated with a very short musical jingle composed on purpose.
Records and interprets/decodes but, in general, does not activate procedures, and stores the notification received (the Information Reference).
Provides for implementing the features, actions, or interactions required by the purposes of the application; for example, it notifies the user of the basic information of the Information Reference and subsequent operational options.
The program should also make it possible to consult the archive of reports received, to delete them, to activate them, to forward them, to share them, etc.

### Comparative Notes

From an application point of view, the use of the QR Code generally involves a direct and intentional interaction by the destination of the information, i.e., the user “sees” the QR code, that is the distinguishable box that identifies it and, voluntarily, he frames it with the webcam of his smartphone or tablet. The software residing in the electronic device interprets the QR code by starting a specific operation that connects to the information prepared by the sender. The use of the new system generally assumes an indirect and predetermined interaction in the Destination's mobile device that “hears” the coded sound signal emitted by a sound source by detecting it, automatically, through the smartphone microphone or any other similar device. The resident software interprets it by starting a specific operation on the device, such as storage, notification, etc., which, subsequently, at the request of the destination, leads to the information prepared by the sender.

In practice, the QR Code is positioned visually and spatially, being reproduced in the form of iconography in predetermined places. The potential Receiver sees it and, only if interested, activates his reading device on his mobile device, frames the code and is directed, generally immediately, to the desired information/interaction of the Sender.

The present new information transmission system, on the other hand, is broadcast through a sound channel and with a specific time indication. That is, it is acoustically diffused at certain time instants by predisposed audio systems. The mobile device (whose APP is active) of the user, i.e., of the Destination, immediately detects the encoded sound signal and stores it, preparing a notification for the potential Destination; on demand, the Destination can start the procedure to access the information or interaction that the Sender desires to transmit.

### Multimedia and Sound-Aided Technologies

A general overview of the current state of the art of multimedia communications is provided, also outlining the importance of sound, integrated and provided in almost all applications and information and dissemination packages.

Multimedia is defined as the characteristic of a communication that integrates several expressive forms in the same support or information context. Generally, multimedia refers to information that can be used, shared and possibly modified anywhere and on different devices.

Aside from the functional aspects of multimedia, which highlight how this type of communication affects culture, economy, sociality, etc., it is important to focus on the physical aspects in reference to the information contents that affect multiple sensory channels.

It is spoken of “multimedia content” when the exchange of information, for specific purposes, makes use of multiple means of mass communication or media used more or less simultaneously, for example: videos or animated images, iconographies or static pictures, audio, such as music and/or speech, written text or publications, and so on. Multimedia is a valuable feature of modern technologies and is, very often, accompanied by interactivity. Thanks to its expressive-communicative potential, multimedia has spread to many areas of society, involving all forms of communication. The web and new media are considered, by their very nature, to be multimedia and interactive.

The audio channel is used as an acoustic media support, or generally intended for listeners (living beings) who directly perceive and interpret the information content carried by sound waves that reach the hearing system.

The sound effects, music, speech, etc. entrusted to the audio channel, now present in numerous multimedia systems, provide an indispensable aid in the context of communication. Still, the audio channel is currently limited in the amount of information that can be delivered to the listening user.

The new information transmission system, using the audio channel as a transmission medium, considerably expands the information that can be functionally integrated into the multimedia and interactive aspects of the communication itself.

### Telecommunications and the Power of Broadcasting

The areas of application of the new information transmission system are innumerable and rely on the audio channel, which is considered to be available in many communication situations.

For illustration purposes, the considerations regarding telecommunications and the so-called “broadcasting” are reported.

In telecommunications, “broadcasting” refers to the transmission of information from a transmitting system to receiving apparatuses having general characteristics that are not specifically defined.

For example: Radio and Television belong to broadcasting systems. The term generically indicates the “one to many” broadcasting model, assuming, especially for transmissions on a large scale, an extremely high quality level of the professional tools used.

Analogously, in computer network systems, we may refer to the context of “streaming”: a data packet can be delivered to all computers connected to the network, for example, to all those on an Ethernet network segment, or to all those of a IP subnet, etc., through interactive procedures.

The most classic example of a broadcasting system is represented by a high power transmitter system and numerous receivers scattered throughout the territory, such as radio equipment in mobile cars, or televisions in homes. In this way, all receivers located in the coverage area of the transmitter will pick up the signal, but the broadcaster will not be able to know exactly whom they are communicating with. Broadcasting is one way: The information is sent without a return channel and without the certainty that all the intended receivers receive it. Nonetheless, the power, effectiveness and usefulness of broadcasting systems are universally recognized and acknowledged.

An encoded sound signal can be sent via different telecommunication paradigms, but broadcasting seems to be the most immediate and natural choice. A sender who regularly broadcast over the radio or television, on a commercial or public service level, information that uses (exclusively or in addition to others) the audio channel, often does not have much time to send, illustrate, and complete his message, and therefore cannot enable the interaction that could be activated and integrated into the mobile devices, now available to everyone.

Thus, the newly proposed information transmission system, which can be adopted in broadcasting communications, would become useful and valuable, because of its practical utilization and advantageous implementation at both destination and sender's sides.

### Applications, Purposes and Use Cases of the New Information Transmission System

Just for the sake of exemplification, the following non-exhaustive list of applications, with reference to the use and purposes of the new system, can be conceived.

For each of them, multiple and diversified implementation projects could be explained, analyzed, developed and synthesized, aimed at social, cultural, didactic, entrepreneurial, economic, . . . goals.

Such application areas could generally include communication and dissemination in situations or contexts where sound diffusion and amplification systems are used, such as:
Radio and Television (broadcasting)
Cinemas and Theaters
Public Places and Events
Schools and Universities
Meetings, Conferences and Congresses
Events and Fairs
Shops and Shopping Malls
Structures for reception and refreshment (Hotel Lounges, Restaurants, Bars, Spas, Waiting rooms)

With the adoption of the new system, in each of the aforementioned relational areas, the Information References can be addressed for the purposes of the information/interaction that the sender wishes to send to the destination(s). The following list defines some among the countless possibilities.
Updates and insights: Documents or information sources of a different nature, in aid of the display of news reports or cultural programs, while they are broadcast on the radio or television.
Further documentations and explanations: Translated or interpreted texts, accompanying illustrations, implementation of procedures, . . . in aid of broadcasts, mainly radio, in Meetings, Conferences and Congresses, during teaching at School or in Universities, in Receptive, Convivial and Refreshments Contexts . . .
Advertising and promotion: Notes, visual contents, animations and additional data, references and contact details, discount coupons, special offers, . . . to enrich and increase the reach of commercial advertisements in audio and video spots that are broadcast on radio or television, but also in Events and Fairs, in Shops and Shopping Malls
Competitions and games: Instructions, rules, and regulations; invitations to participate, interaction, further entertainment
Surveys and polls: Statistical research, direct or indirect surveys, interactive questionnaires in real time, . . .
Further utilities and accompanying documents: Attributions, stories, references, testimonials, certifications, reviews, pictures,

The new system can also be used in times and situations when immediate and practical interactions between mobile devices or between mobile devices and fixed devices are required, in operational circumstances requiring data exchange or interrelationship, such as:
access and/or direct connection for the transfer of data, information and iconographic sources:
transmission of recognition credentials and accreditation operations:
redirection to in-depth information sources:
start of interactivity operations between applications:

### Field of Innovation

Today's technology utilizes “visual” transmission together with codes that, detected by optical reading devices, are easily and immediately interpreted by software programs that translate, mostly immediately, the information that a sender wishes to send to any concerned destination.

The innovation of the present system refers to a code, acoustically perceptible and detectable by microphones (or transducer devices of the electroacoustic type) whose purpose is to input information into a computer or a similar device; in more detail, it refers to a sound signal composed of different frequencies variously modulated that “carry” data in binary language. The structure of the acoustic signal is such that it is encoded according to a specified model that guarantees an adequate level of security (encryption) and reliability (reconstruction of the original information).

The process of production and emission of a sound signal, to be acoustically diffused in a transmission medium such as, for example, air, provides that the original information, which in our case is in the form of a binary code available as an electrical signal, is subject to a conversion, possibly over multiple steps if needed, and to an implementation in modulated frequencies in the sound domain, possibly including infra- and ultra-sound.

The electrical signal is subsequently amplified and sent to an electro-acoustic transducer, that is an actuator which converts it into sound pressure waves, such as a loudspeaker, and which provides for propagation in the transmission medium.

A generally known method of acquiring, recording, and decoding a sound signal includes steps to detect the sound by means of an electro-acoustic type transducer device such as a microphone and, after detecting the specific modulated frequencies, relying on a software program that transposes the code in terms of bits. The latter operation must provide, without ambiguity, the original binary code, that is, the one encoded to be transposed and broadcast in the sound signal.

### Control Procedure or ISP-BACK

The Information Reference does not need to directly contain the information/data that the Sender wants to transmit, nor the URL address to access content, but rather that it contains a command to initiate an authorization request procedure.

The destination's electronic device will receive the coded sound signal that is processed by the program installed in the device. This program activates the ISP authorization request procedure, for example by calling, sending a message, accessing the website, etc. With this procedure, the Destination then requests the ISP to be able to access the content of the Information Reference. At this point, the ISP verifies the Sender's authorization request and sends to the Destination, or rather to the program installed in the electronic device of the Receiver's itself, the Information Reference containing the data/information that the Sender wants to transmit. This procedure prevents the Destination from accessing, for example, unverified or unauthorized content via a URL address.

Such an ISP-BACK procedure is represented in FIG. 5.

Therefore, with reference to the above description, the following claims are expressed.

1. A method for transmission of Information References that comprise information or data, wherein said Information References in turn contain data/information to initiate procedures aimed at sending additional information/interactions/data to one or more Destinations, the method comprising:
defining the Information References following specific conventional formats to be transmitted by a Sender to one or more Destinations;
generating an encoded sound signal that contains said Information References;
transmitting and emitting said encoded sound signal with at least one first transducer or loudspeaker;
receiving with at least one second transducer or microphone of said encoded sound signal emitted by the at least one first transducer or loudspeaker; and
decoding said encoded sound signal to start the procedures which lead to the sending of additional information/interactions/data that the Sender desires the one or more Destinations to obtain.

2. The method for transmission of Information References, as per claim 1, wherein generating the encoded sound signal includes the following steps:
transposing said information or data to be transmitted in one or more strings of bits or in one or more character sequences to be encoded;
encoding by transforming the one or more strings of bits or character sequences into audio signals of predetermined duration with overlapping frequencies over time; and
saving in one or more digital audio files.

3. The method for transmission of Information References, as per claim 2, wherein said one or more digital audio files are in mp3 or wav or midi or aac format or another format that can be reproduced and/or readable by an electronic device.

4. The method for transmission of Information References, as per claim 1, wherein said encoded sound signal is composed of one or more sound frequencies.

5. The method for transmission of Information References, as per claim 2, wherein encoding comprises a two-dimensional encoding which includes at least the following:
determining a frequency range containing A values chosen as harmonics;
determining an overall duration of the encoded sound signal, divided into T time intervals;
developing a two-dimensional matrix A×T;
inserting in said two-dimensional matrix of digital values according to a predefined coding scheme; and
transducing the digital values of the two-dimensional matrix in an acoustic domain, reading the digital values according to directions of time and frequency.

6. The method for transmission of Information References, as per claim 2, wherein encoding further includes introducing signal redundancy into the encoded sound signal for noise attenuation.

7. The method for transmission of Information References, as per claim 2, wherein encoding further includes introducing end-to-end encryption.

8. The method for transmission of Information References, as per claim 1, wherein said encoded sound signal comprises:
at least a first part or opening marker that indicates a start of signal transmission;
at least one central part that contains said information or data to be transmitted in a coded format; and
at least one last part or closure marker indicating an end of the signal transmission.

9. The method for transmission of Information References, as per claim 1, wherein decoding the encoded sound signal takes place according to the following steps:
interpreting a structure of digital values in time and frequency directions of the received sound signal; and
decoding a digital sequence with removal of redundancy.

10. The method for transmission of Information References, as per claim 1, wherein said information or data to be transmitted comprise at least one URL address.

11. An information or data transmission system configured to implement a method as per claim 1, comprising:
at least one first electronic coding device, in which at least one processing program configured for coding information or data in at least one coded sound signal is installed;
at least one loudspeaker configured to emit said coded sound signal;
at least one microphone adapted to receive said coded sound signal emitted by at least one of the at least one loudspeaker; and
at least one second electronic device at a receiver's side connected to said at least one microphone and in which at least one processing program is installed, configured at least to decode said coded sound signal.

12. The information or data transmission system as per claim 11, wherein said at least one second electronic device of the receiver is a mobile phone or a tablet or other electronic device comprising said at least one microphone and in which said at least one processing program is installed.

13. The information or data transmission system as per claim 11, further comprising an additional electronic device of the sender, adapted to receive said coded sound signal from the at least one first electronic coding device and configured to send said coded sound signal to a plurality of sound emission systems comprising said at least one loudspeaker.
